(19) United States
(12) Patent Application Publication
(10) Pub. No.: US 2002/0164903 A1
(43) Pub. Date: Nov. 7, 2002

(54) Interference free connector

(75) Inventor: Chen-Wen Chuang, Taipei (TW)

Correspondence Address: Kolisch, Hartwell, Dickinson, McCormack & Heuser, Suite 200, 520 S.W. Yamhill Street, Portland, OR, 97204-1378, US

(73) Assignee: Holly Hand Enterprise Co., Ltd.

(21) Appl. No.: 09/848,824

(22) Filed: May 3, 2001

(51) Int. Cl. H01R 13/66; H01R 33/945

(52) U.S. Cl. 439/620

(57) ABSTRACT

The connector has a socket with two parallel rows of holes formed from the front face to the rear face and a tube inserted in each hole and extending from the rear face of the socket and an insert securely inserted between the two parallel rows of tubes and having multiple capacitors each connected to one of the tubes so as to eliminate electromagnetic interference.

### BACKGROUND OF THE INVENTION

1. Field of the Invention

The present invention relates to an interference free connector, and more particularly to a connector with multiple capacitors to filter out high frequency noise and electromagnetic interference.

2. Description of Related Art

With reference to FIG. 5, a conventional computer connector (50) has a socket (51), multiple wires (52) connected to and extending out from the socket (51) and holes (53) defined through the socket (51) from the front face to the back face. Each hole (53) corresponds to one of the wires (52). When the conventional connector (50) is used, a signal is transmitted through each of the wires (52) in the socket (51). Electromagnetic interference and/or high frequency interference often occur around the wires (52), which can seriously affect the precision of the transmitted signal. To reduce or obviate the interference, a ferrite core (54) is mounted around the wires (52). The ferrite core (54) is made of metal, occupies a large space and makes up a large portion of the weight of the connector (50). The addition of the ferrite core (54) to the connector (50) not only increases the weight of the connector (50), but also increases the volume of the connector (50), which is a major weak point in the market where everything should be as small as possible and as efficient as possible.

To overcome the shortcomings, the present invention intends to provide an improved connector to mitigate and obviate the aforementioned problems.

### SUMMARY OF THE INVENTION

The primary objective of the invention is to have a connector with a socket, wires electrically connected to the socket and a circuit board securely connected between the socket and the wires and having multiple capacitors formed on the circuit board to correspond to the wires. With such an arrangement, the electromagnetic interference is able to be obviated.

Other objects, advantages and novel features of the invention will become more apparent from the following detailed description when taken in conjunction with the accompanying drawings.

### BRIEF DESCRIPTION OF THE DRAWINGS

FIG. 1 is a top plan view of the connector in accordance with the present invention;

FIG. 2 is an exploded top plan view of the connector in FIG. 1 showing the socket and the insert;

FIG. 3 is a front plan view of the connector in FIG. 1 showing the engagement of the insert to the extended tubes formed on a side face of the connector;

FIG. 4 is an enlarged front plan view of the connector in FIG. 1 showing the engagement between the extended tubes and the capacitors on the insert; and

FIG. 5 is a perspective view of a conventional connector.

### DETAILED DESCRIPTION OF PREFERRED EMBODIMENT

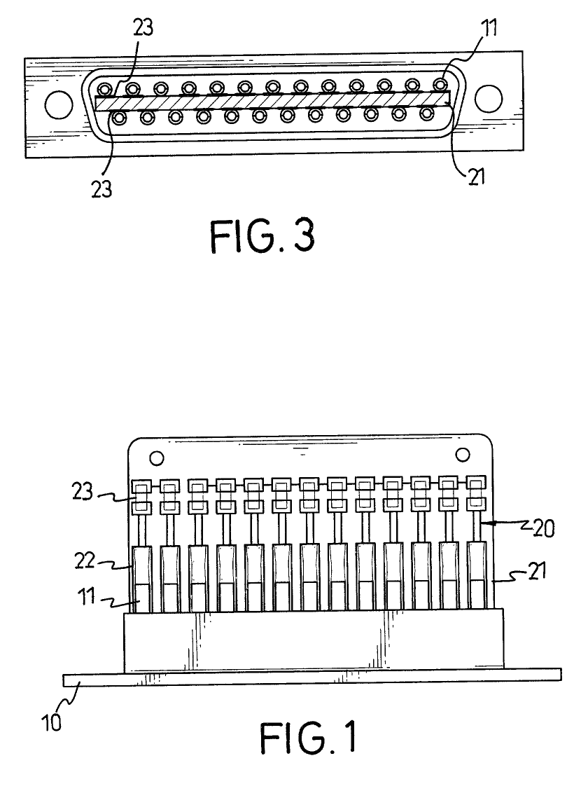

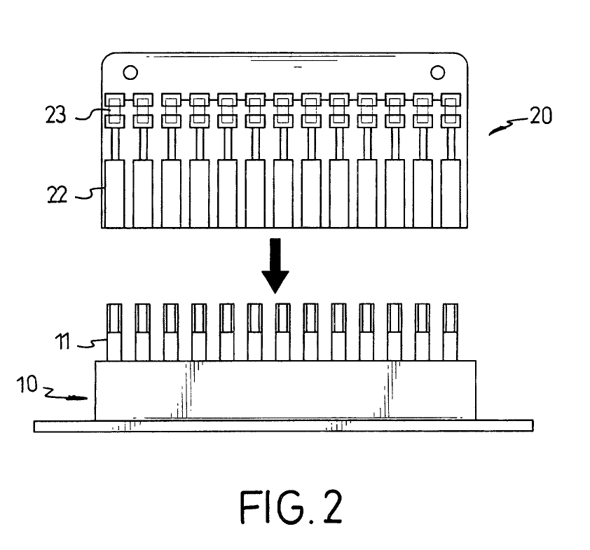

With reference to FIGS. 1˜3, the connector in accordance with the present invention has a socket (10) and an insert (20).

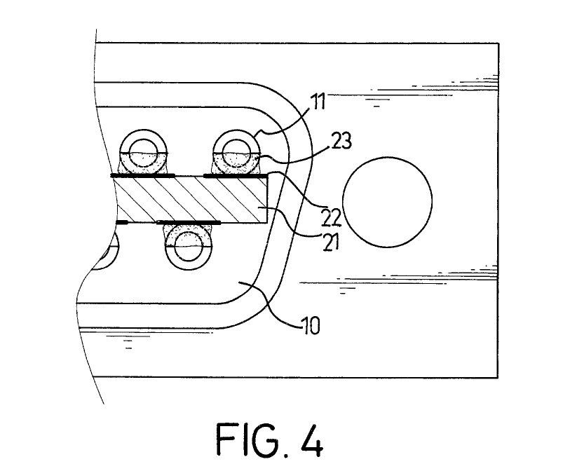

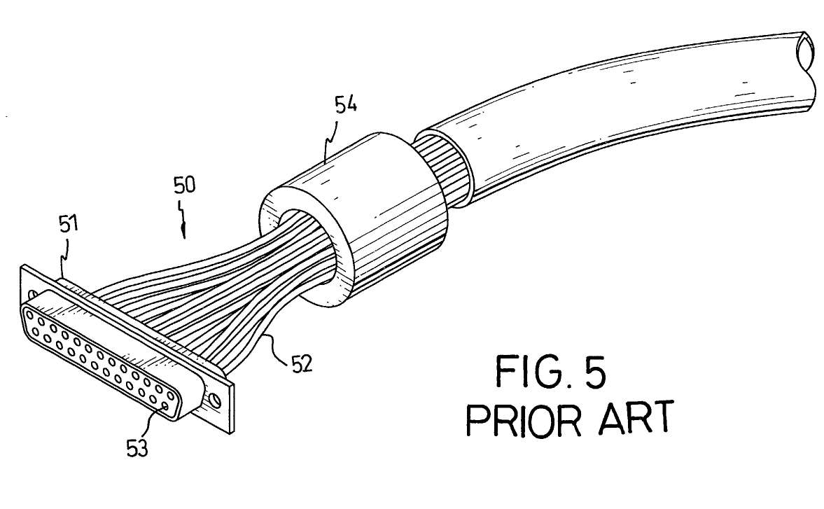

The socket (10) has a front face, a rear face, two parallel rows of holes (not numbered) formed through the socket from the front face to the rear face and a tube (11) inserted in each hole and extending from the rear face of the socket (10). Because the basic structure of the socket (10) is the same as that described in the Description of Related Art, reference numbers for the holes are omitted on FIGS. 3 and 4.

The insert (20) has a circuit board (21), pads (22) and capacitors (23). The circuit board (21) has a top and a bottom face. The pads (22) are integrally formed on the top and bottom faces of the circuit board (20) to correspond to one of the tubes (11) extending from the socket (10). Each capacitor (23) is securely attached to one of the pads (22) to correspond to one of the tubes (11). The engagement between the capacitors (23) and the pads (22) allows an electrical communication between the capacitors (23) and the pads (22).

When the connector is assembled, the circuit board (21) is inserted between the two parallel rows of tubes (11) extending from the socket (10) to allow each one of the pads (22) to be in contact with one of the tubes (11). After the engagement between the capacitors (23) and the tubes (11), a surface mounting technology, such as soldering, is used to secure the engagement of the capacitors (23) and the extended tubes (11). After the assembly is finished, the connector is then able to obviate the previously mentioned electromagnetic interference induced by the signal transmission. Further, the size of the capacitor (23) can be selected to accommodate different signal strengths.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A connector comprising:
a socket with a front face and a rear face having two parallel rows of holes defined in the socket from the front face to the rear face and tubes inserted in the holes extending from the rear face of the socket; and
an insert with a top and bottom face securely inserted between the two parallel rows of tubes extending from the rear face of the socket and having pads formed on the top and bottom faces of the insert to correspond to the tubes extending from the socket and capacitors each formed to correspond to one of the pads so as to correspond to one of the tubes.
